(19) United States
(12) Patent Application Publication
(10) Pub. No.: US 2008/0319605 A1
(43) Pub. Date: Dec. 25, 2008

(54) FUEL MONITORING DEVICE, SYSTEM, AND METHOD

(76) Inventor: James Keith Davis, San Antonio, TX (US)

Correspondence Address: RAMAN N. DEWAN;JACKSON WALKER, L.L.P., 100 CONGRESS AVENUE, SUITE 1100, AUSTIN, TX, 78701, US

(21) Appl. No.: 11/768,123

(22) Filed: Jun. 25, 2007

(51) Int. Cl. G06F 19/00

(52) U.S. Cl. 701/35; 701/123

(57) ABSTRACT

A fuel consumption device is suitable for insertion into a diagnostic port of a motor vehicle. The device is operable to receive a fuel gauge signal and one or more powertrain signals. The device estimates fuel consumption based on said one or more powertrain signals and uses the estimated fuel consumption data to generate a fuel consumption database. The database indicates a relationship between a fuel gauge signal and actual amounts of fuel. Upon detecting a refueling event, the device consults a fuel consumption database to determine an estimated amount of fuel associated with the refueling event. The powertrain signals may include a mass air flow signal. The device may be able to store the fuel consumption database locally and transmit the database remotely. The device is still further preferably operable to record and transmit a record of the refueling event that includes an estimated amount of fuel.

### BACKGROUND

1. Field of Invention

The invention is in the field of managing a fleet of motor vehicles and, more specifically, acquiring, maintaining, and verifying fuel consumption data for a fleet of motor vehicles.

2. Description of Related Art

Many businesses maintain a fleet of motor vehicles to transport raw materials, equipment, finished products, employees, customers, and so forth. A major expense associated with a motor vehicle fleet is the fuel costs required to keep the fleet in transit. For multiple reasons, it is beneficial for fleet operators to have accurate fuel consumption data for each vehicle in the fleet.

Accurate fuel consumption data is useful, for example, to reduce fraud and theft associated with the purchasing of fuel for a fleet vehicle. Many fleet operators maintain a fleet “yard” that includes, in addition to sufficient surface area for storing the fleet vehicles, one or more fuel pumps to provide a centralized and local refueling environment. The fuel pumps in a fleet yard may include devices attached to a portion of the fuel pump to provide accurate information regarding the amount of fuel dispensed to a fleet vehicle. For this reason and others, the risk of fuel theft or fraud is relatively low when a fleet vehicle refuels in the yard. It is not uncommon, however, for a fleet vehicle to refuel at a commercial filling station that is not under the control of the fleet operator. Remote refueling may occur, for example, if a fleet vehicle requires refueling at a time when the vehicle is far from the fleet yard. A school bus required to refill during a road trip, for example, will generally have to refuel at a commercial filling station.

When unscrupulous drivers or operators refuel away from the fleet yard, they may have an opportunity to turn in a receipt that indicates more fuel that was actually dispensed to the fleet vehicle. As an example, a driver may fill his or her private vehicle using all or some of the fuel referenced in a fleet refueling receipt. Moreover, even if a fleet's drivers and operators are extremely honest, mistakes can occur. Without an accurate way to measure fuel consumption and fuel refilling for each fleet vehicle, keeping track of information necessary to reduce the risk of fuel theft and/or refueling errors is difficult and time consuming.

### SUMMARY

Disclosed herein are aspects of a device, system, and method for acquiring and monitoring fuel consumption information that are particularly suitable for use in the context of a fleet of motor vehicles.

In one aspect, a fuel consumption device suitable for insertion into a diagnostic port of a motor vehicle is operable to receive a fuel gauge signal and one or more powertrain signals including, e.g., a mass air flow signal. The device is also operable to estimate fuel consumption based on the powertrain signal(s). The device uses the fuel consumption estimation functionality, in conjunction with the fuel gauge signals, to generate a fuel consumption database indicative of the relationship between fuel gauge readings and actual amounts of fuel. For example, the fuel consumption database may include information from which the actual amount of fuel corresponding to a change in fuel gauge reading caused by a refueling event is determinable.

Upon detecting a refueling event, the device is operable to consult the fuel consumption database to determine an estimated amount of fuel associated with the refueling event. The device may be operable to store the fuel consumption database locally and/or transmit the database remotely. The device may be further operable to record and transmit a record of the refueling event including the estimated amount of fuel.

In another aspect, a fuel monitoring device for use with a motor vehicle includes a processing module, an interface, and a storage device. The interface facilitates communication between the processing module and an electronic control module (ECM). The interface is operable to receive a fuel gauge signal and at least one powertrain signal from the ECM. The storage device includes a computer readable medium that is accessible to the processing module.

The fuel monitoring device further includes a code module including instructions embedded in the computer readable medium and executable by the processor. The code module, when executed, determines from the powertrain signal(s) an amount of fuel consumed by the motor vehicle during a specific interval. The code module detects a first reading of the fuel gauge signal at the beginning of the interval and a second reading of the fuel gauge signal at the end of the interval. The code module then associates the amount of fuel consumed with the first and second readings of the fuel gauge signal.

The powertrain signal(s) may include a mass air flow (MAF) signal, an O2 sensor signal, an odometer signal, as well as other signals. The monitoring device may repeat the described process for a plurality of different intervals to build a fuel consumption database including information indicative of an amount of fuel consumption associated with a pair of fuel gauge readings. The monitoring device may also store the fuel consumption database locally in storage device and/or transmit the fuel consumption database to an external data processing system using local wireless, wide area wireless, or a wireline technology. Local wireless transmission may be to a wireless receiver device that is mounted on or is otherwise a part of a fuel pump. The fuel monitoring device may also calculate and storage a mileage figure associated with the amount of fuel consumed. The mileage figure may be adjusted over time as subsequent mileage figures are established.

In still another aspect, A method of monitoring fuel consumption includes recording a beginning reading of the fuel gauge upon detecting the beginning of a refueling event. An ending reading of the fuel gauge is then taken at the end of the refueling event. A fuel consumption database indicative of a relationship between fuel gauge readings and fuel consumption is then consulted to determine or estimate an amount of fuel associated with the refueling event. The estimated amount of fuel along with the initial and ending fuel gauge readings may be recorded locally in a refueling database. Additional data associated with the refueling event may also be recorded in the refueling database. The additional data may include date, time of day, location, operator identification information, and vehicle identification information. The refueling database may then be transmitted to an external data base. The external database may include, in addition to the estimated amount of fuel, a reported amount of fuel associated with the refueling event. A discrepancy between the determined amount of fuel and the reported amount of fuel may then be detected.

### BRIEF DESCRIPTION OF THE DRAWINGS

Aspects of one or more embodiments are illustrated by way of example and are expressly not limited by the accompanying drawings, in which like references indicate similar elements, and in which:

FIG. 1 is a block diagram of selected elements of an embodiment of a fuel data acquisition system;

FIG. 2 is a block diagram of selected elements of an embodiment of a fuel monitoring device depicted in the system of FIG. 1;

FIG. 3 is a flow diagram of an embodiment of a method of obtaining data that facilitates accurate monitoring of fuel consumption;

FIG. 4 is a flow diagram of an embodiment of a method of determining an accurate refueling estimate based on readings from an inaccurate measurement device including, as an example. a conventional fuel gauge;

FIG. 5 is a conceptual depiction of an implementation of a fuel consumption database;

FIG. 6 is a conceptual depiction of an embodiment of a local refueling database; and

FIG. 7 is a conceptual depiction of an embodiment of an external refueling database.

Although aspects of the one or more exemplary embodiments illustrated are described in detail herein, the depiction and description of these aspects is not intended to limit the invention to the particular embodiment disclosed. To the contrary, the claims are intended to encompass, for example, all equivalent and alternative aspects and embodiments that would occur to one of ordinary skill in the art having the benefit of this disclosure.

Elements in the drawings may be presented for simplicity and clarity and may not been drawn to scale. For example, the dimensions of any physical or mechanical elements in the drawings may be exaggerated relative to other elements to clarify or improve the understanding of the embodiments of the present invention. In addition block diagrams and flow diagrams may illustrate selected elements of methods, processes, data structure, and software conceptually.

### DETAILED DESCRIPTION

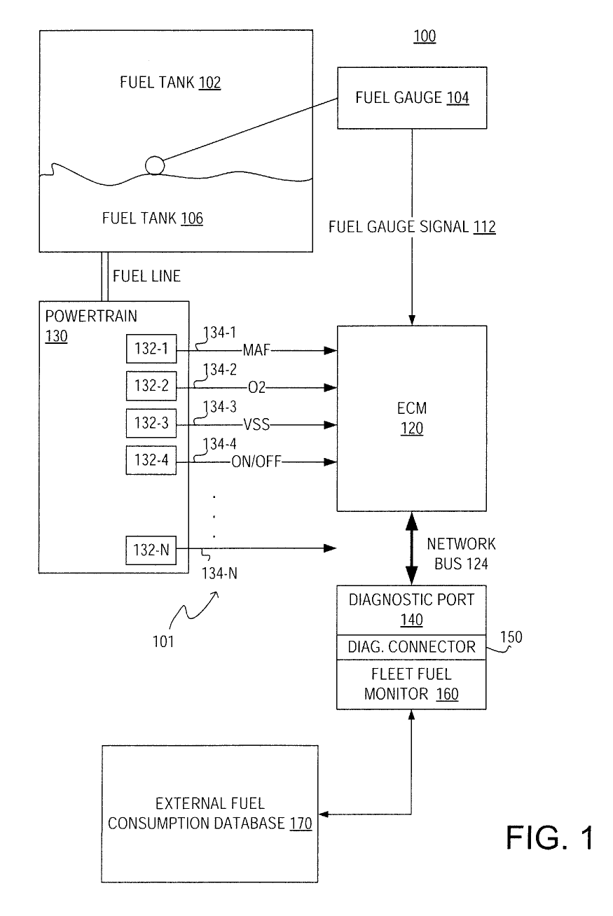

Referring to the drawings, FIG. 1 depicts selected elements of an embodiment of a system 100 suitable for accurately monitoring and tracking fuel consumption and refueling data associated with a motor vehicle 101. In the depicted implementation, vehicle 101 is an element of system 100. In some embodiments, vehicle 101 is one of a fleet of vehicles owned and/or operated by a commercial, educational, or governmental entity.

As depicted in FIG. 1, vehicle 101 of system 100 includes a fuel tank 102, a fuel gauge 104, an electronic control module (ECM) 120, a powertrain 130, and a fuel monitor 160. Fuel tank 102 as depicted includes a volume of fuel 106. Fuel gauge 104 generates a fuel gauge signal 112 indicative of the volume of fuel 106 in fuel tank 102. As used in this disclosure, powertrain 130 includes all components that generate power and deliver it to the road surface. These include the engine, transmission, driveshafts, differentials, and the wheels.

Fuel gauge 104 may be of the float and wiper arm variety suggested by FIG. 1. In these embodiments, a float device is connected to one end of a wiper arm and positioned in the fuel tank 102 to float at the surface of fuel 106. The wiper arm position may determine a resistance or other electrical characteristic, that is provided to a fuel gauge circuit (not shown explicitly). The fuel gauge circuit is configured to control the positioning of a pointer needle or other indicator of the remaining fuel as is well known in the field of automotive design. Although the depicted embodiment of fuel gauge 104 is of the float variety of fuel gauges, other embodiments may be used as well.

In some embodiments, the fuel gauge indicator signal 112 produced by fuel gauge 104 is an analog signal. In other embodiments, fuel gauge indicator signal 112 might be a digital signal. Although the depicted implementation illustrates fuel gauge indicator signal 112 being provided directly from fuel gauge 104 to ECM 120, other embodiments of vehicle 101 and/or system 100 may include intermediate circuitry that could perform various functions, for example, to convert fuel gauge signal 112 to a digital signal, format the signal for compatibility with ECM 120, or modify signal 112 in some other way.

As depicted in FIG. 1, fuel gauge signal 112 is provided to and received by ECM 120. ECM 120 is preferably an electronic control unit that controls aspects of an internal combustion engine's operation. ECM 120 may, for example, control the quantity of fuel injected into each cylinder during each engine cycle. ECM 120 may also control ignition timing, cam timing, turbocharger boost, and other parameters. ECM 120 preferably determines the quantity of fuel, ignition timing, and other parameters by monitoring one or more sensors 132-1 through 132-n, generically or collectively referred to herein as sensor(s) 132. Sensors 132 may include, as examples, a mass airflow (MAF) sensor, an oxygen sensor, a throttle position sensor, an air temperature sensor, an engine coolant temperature sensor, and many others. In FIG. 1, the depicted sensors 132 include a MAF sensor 132-1, an oxygen (O₂) sensor 132-2, a vehicle speed sensor (VSS) 132-3, and an On/Off sensor 132-4. As its name suggest, On/Off sensor 132-4 generates an on/off signal 134-4, preferably digital, indicating whether powertrain 130 is running or not. MAF sensor 132-1 produces a MAF signal 134-1 having a voltage that reflects the amount of air drawn into an engine. Similarly, O2 sensor 132-2 generates O2 signal 134-2 indicative of the oxygen content of the exhaust and VSS 132-3 generates VSS signal 134-3 indicative of the speed of a transmission transaxle or wheel and from which odometer and speedometer information can be derived.

ECM 120 preferably includes on-board diagnostic (OBD) functionality. In the automotive context, OBD is a generic term referring to a vehicle's self-diagnostic and reporting capability. OBD systems give the vehicle owner or a repair technician access to state of health information for various vehicle sub-systems. The amount of diagnostic information available via OBD has varied widely since the introduction, in the early 1980's, of ECM's and other on-board vehicle computers. Early OBD devices were configured, for example, to illuminate a malfunction indicator light if a problem was detected, but these devices did not provide information as to the nature of the problem. More recent OBD implementations use a standardized fast digital communications port to provide real time data and a standardized set of diagnostic trouble codes, which allow a technician to identify and remedy vehicle malfunctions. Standards for implementing OBD have been in existence since at least 1987, when a set of standards that would later be referred to as OBD-I were issued by the California Air Resources Board (CARB). In the mid 1990's, CARB issued OBD-II and mandated OBD-II compliance for all cars sold in California. In 1996, OBD-II compliance became mandatory for all cars sold in the U.S. Federal OBD II standards are controlled by the U.S. Environmental Protection Agency. See, e.g., 40 CFR 86.005-17 et seq. OBD-II specifies the type of diagnostic connector and its pinout, the electrical signaling protocols available, and the messaging format. OBD-II also provides a list of vehicle parameters to monitor along with how to encode the data for each.

In the embodiment of vehicle 101 depicted in FIG. 1, ECM 120 is connected via a network bus 124 to a communication port referred to herein as diagnostic port 140. Network bus 124 enables the transfer of diagnostic and other information from ECM 120 to an external user. Diagnostic port 140 is shown as terminating at a diagnostic connector 150.

In some embodiments, ECM 120 is an OBD-II compliant ECM, diagnostic port 140 is an OBD-II compliant port, also referred to simply as an OBD-II port, diagnostic connector 150 is an OBD-II compliant connector, and network bus 124 is an OBD-II compliant bus. In OBD-II compliant embodiments, diagnostic port 140 is a standardized 16-pin female connector that is typically located on the underside of or in proximity to a vehicle's steering column. Although an OBD-II compliant implementation is shown in FIG. 1, other embodiments may employ alternative standards including, as examples, the J1939, J1587, and J1708 standards from the Society of Automotive Engineers (SAE).

System 100 as depicted in FIG. 1 further includes a fuel monitor 160 connected to diagnostic connector 150 of diagnostic port 140. In some embodiments, fuel monitor 160 is enabled to receive fuel gauge signal 112 or other information indicative of a reading of fuel gauge 104. In addition, some embodiments of fuel monitor 160 also receive one or more signals 134 provided by sensor(s) 132 of powertrain 130. The depicted embodiment of fuel monitor 160 is enabled to use one or more of the signal(s) 134 to determine fuel consumption independently of the fuel gauge reading. Fuel monitor 160 is preferably enabled to correlate the independently determined measure of fuel consumption to the fuel gauge readings and thereby generate information in the form of a local fuel consumption database, table, function, graph, or the like that accurately indicates the amount of fuel 106 required to change the fuel gauge reading from a first value to a second value for any pair of fuel gauge values.

In addition, some embodiments of fuel monitor 160 are operable to detect a refueling event. For example, some embodiments of fuel monitor 160 are configured to detect a relatively rapid change in fuel gauge signal 112. For example, some embodiments of fuel monitor 160 interpret a rapidly increasing change in fuel gauge signal 112 as indicative of a refueling event. Fuel monitor 160 is operable to record the reading of fuel gauge signal 112 at the start of a refueling event and at the end of the refueling event, when the rapid change in fuel gauge signal 112 ceases. By recording readings of fuel gauge signal 112 at the start and end of a refueling event and consulting the local fuel consumption database, embodiments of fuel monitor 160 are enabled to provide an independently derived indication of the amount of fuel 106 added to fuel tank 102 during a refueling event.

The independently derived indication of the amount of fuel obtained may then be recorded locally in a refueling database and/or transmitted, wirelessly or otherwise, to an external refueling database 170. External refueling database 170 may be implemented as a centralized or distributed database. External refueling database 170 may include a plurality of refueling entries where each entry corresponds to a refueling event. Each refueling entry may include two or possibly indications of the amount of fuel corresponding to the refueling event. One of the indications of fuel amount is preferably the independently determined estimate of fuel made possible by fuel monitor 160 and refueling module 220. The other indication of fuel amount may be an amount reported by the operator or driver either manually or via an electronic or paper refueling receipt. If a discrepancy arises between the two or more indications of the amount of fuel associated with a particular refueling event, the discrepancy can be investigated to determine the cause. In this manner, any discrepancies arising because of fraud or mistake on the part of the vehicle driver or refueling operator can be identified.

In addition to providing a basis for fraud detection functionality, the independently derived fuel consumption data generated by fuel monitor 160 may be used beneficially to track fuel costs accurately for each vehicle in a fleet. Fuel cost data is useful to fleet operators for a number of reasons. Vehicle purchase selections, for example, might be influenced by the fuel costs associated with the vehicles. In addition, fuel consumption information might be useful from a maintenance and cost control perspective to identify vehicles that appear to be exhibiting abnormally high fuel consumption. More generally, accurate fuel consumption information may be useful to optimize vehicle parameters for fuel efficiency.

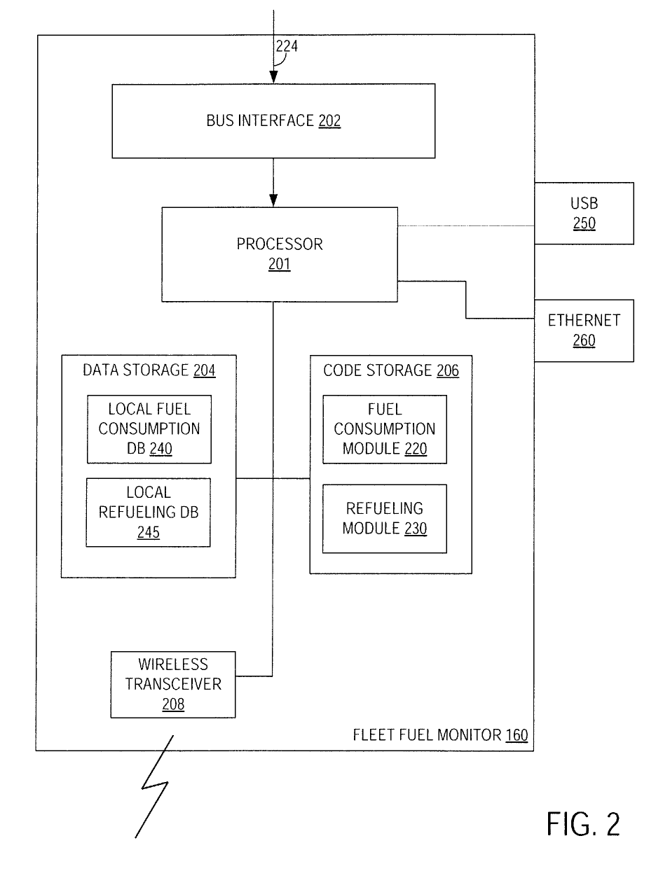

Referring now to FIG. 2, selected elements of an embodiment of fuel monitor 160 are depicted. In the depicted embodiment, fuel monitor 160 includes a processor module 201, a bus interface 202, data storage 204, code storage 206, and a wireless transceiver 208. Other implementations of fuel monitor 160 may not include all of the elements depicted in FIG. 2. For example, some embodiments of fuel monitor 160 may not include a wireless transmitter or no wireless communication device instead of a wireless transceiver 208.

Processor module 201 may be implemented as a general purpose microprocessor or central processor (CPU) including, e.g., an x86 type processor from Intel or Advanced Micro Devices. In other embodiments, processor module 201 may be implemented using an embedded processor, controller, micro controller, or the like. In still other embodiments, processor module 201 may be implemented using a combination of field programmable logic, microcode, and associated peripheral devices. Moreover, all or some of the other depicted elements of fuel monitor 160 may be integrated within processor module 201.

Bus interface 202 facilitates communication between processor 201 and external devices via an external interconnect or bus 224. For OBD-II embodiments, external bus 224 represents an OBD-II compliant implementation of network bus 124 as depicted in FIG. 1 and bus interface 202 is an OBD-II bus interface. Bus interface 202 may include buffers, registers, and clocking circuits necessary to communicate data and commands between processor 201 and bus 224. The embodiment of fuel monitor 160 depicted in FIG. 2 also includes industry standard ports or interfaces including, as examples, a universal serial bus (USB) port 250 and an Ethernet port 260 suitable for connecting fuel monitor 160 as a peripheral device to an external data processing system.

The depicted embodiment of fuel monitor 160 illustrates code storage 206 containing a fuel consumption module 220 and a refueling module 230. In addition, fuel monitor 160 as depicted in FIG. 2 includes a local fuel consumption database 240 and a local refueling database 245 in data storage 204. In some embodiments, code storage 206 represents a computer readable or processor readable medium and fuel consumption module 220 and refueling module 230 represent computer executable or processor executable instructions that are stored in or embedded in the medium. Data storage 204 and code storage 206 may be integrated within a single storage device or component. Both data storage 204 and code storage 206 may include either volatile storage elements such as dynamic or static random access memory (RAM) elements, nonvolatile storage elements such as flash memory or other suitable persistent storage elements, or both.

As suggested by its name, wireless transceiver 208 as depicted in FIG. 2 enables wireless communication between fuel monitor 160 and external devices. Wireless transceiver 208 may include functionality to communicate via a local wireless protocol such as Bluetooth or WiFi or via a wide area protocol such as CDMA or GSM, or both. In the depicted embodiment, transceiver 208 may receive wireless information as well as transmit wirelessly. In other embodiments, a wireless transmitter (not depicted) may be used in lieu of wireless transceiver 208 to reduce cost and simplify the design.

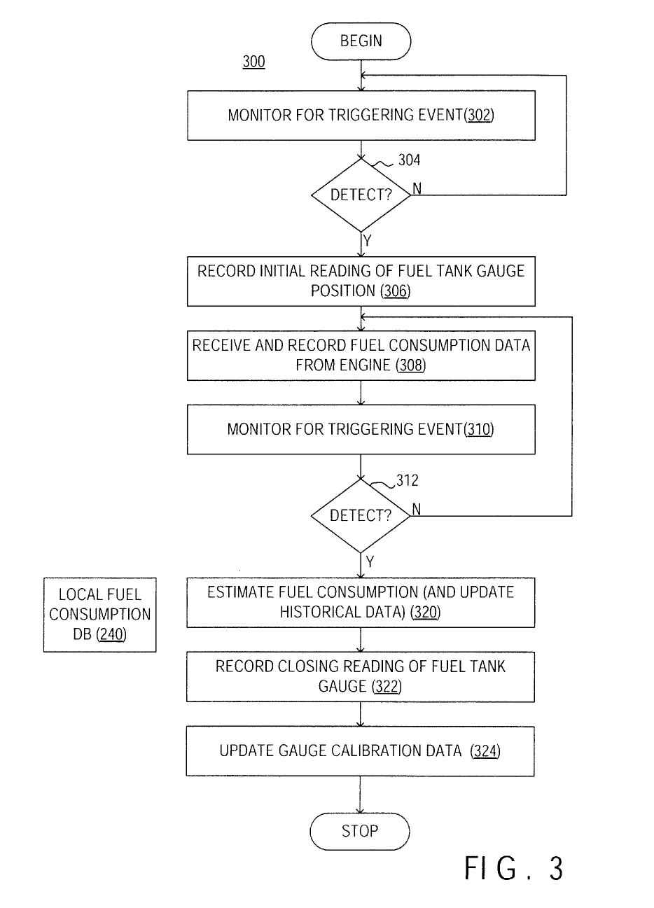

Referring now to FIG. 3, a flow diagram depicts a method 300 that is performed when processing module 201 of fuel monitor 160 executes one embodiment of fuel consumption module 220. In the depicted embodiment, method 300 generates local fuel consumption database 240 by correlating fuel gauge readings against independently determined estimates of fuel consumption. By associating accurate fuel consumption estimates against different pairs of fuel gauge readings, method 300 is operable to populate a large number of data points that will be useful to determine the characteristic relationship between fuel gauge readings and actual amounts of fuel for a given vehicle.

As depicted in FIG. 1, method 300 includes acquiring fuel consumption data during an interval defined by a pair of triggering events including a first triggering event and a second triggering event. Fuel gauge readings are taken at the time of the triggering events. The fuel consumption data acquired between the triggering events is then used to determine a fuel consumption estimate. The fuel consumption estimate is then associated with the pair of fuel gauge readings and recorded. In this manner, method 300 creates data from which a user can accurately correlate or convert a fuel gauge reading to an amount of fuel. Over time, repeated execution of fuel consumption module 220 and method 300 populate and refine the local fuel consumption database 240 so that the amount of fuel as a function of fuel gauge reading is substantially known. Although described in terms of pairs of fuel gauge readings, local fuel consumption database 240, once populated, may also provide actual fuel information based on a single reading of fuel gauge signal 112.

In FIG. 3, method 300 monitors (block 302) for a first triggering event. In some embodiments, the first triggering event represents an event that can be associated with a refueling event. Although the triggering event might be any number of events, the triggering event that best indicates a refueling event is a generally desirable event on which to trigger. The triggering event might, for example, represent powertrain 130 change from an “on” state to an “off” state or vice versa since refueling is frequently performed with the engine in an off state. The on/off transition is a desirable trigger event in terms of its ease of detection, but the on/off event is only loosely correlated to refueling event since it is only at selected on/off stops that fuel is acquired. As another example, the triggering event might be the detection of a relatively rapid change in the readings of fuel gauge signal 112. A relatively rapid change fuel gauge signal 112 might correlate more directly indicate a fueling event or, conversely, a siphoning event. In still other embodiments, a combination of the on/off signal and fuel gauge signal 112 may be used so that, for example, a refueling event is detected when fuel gauge signal 112 rises during a time when the vehicle is off.

If, in decision block 304, a triggering event is detected, the depicted embodiment of method 300 includes recording (block 306) an initial reading of fuel gauge signal 112. After recording the initial reading of fuel gauge signal 112, method 300 includes receiving and possibly storing (block 308) fuel consumption data. In some embodiments, as discussed previously, the fuel consumption data received in block 308 is extracted from one or more powertrain signals which include, for example, signals 134 generated by sensors 132 on powertrain 130. The powertrain signals may be routed to fuel monitor 160 via ECM 120. An example of an powertrain signal suitable for providing an independent measure of fuel consumption is mass air flow (MAF) signal 134-1 produced by sensor 132-1. MAF signal 134-1 is indicative of the amount of air injected into combustion chambers of powertrain 130. Under normal operating conditions the air:fuel ratio is substantially constant and, as such, MAF signal 134-1 is indirectly indicative of fuel consumption. In one embodiment, the data provided by MAF signal 134-1 is converted directly to fuel consumption data based on the constant air:fuel ratio assumption. In other embodiments, more accurate fuel consumption data may be achieved by monitoring additional powertrain signals and/or adjusting the interpretation of existing signals to account for variations in the air:fuel ratio. When powertrain 130 is cold, for example, or when powertrain 130 is operating at high RPM, powertrain 130 may intentionally decrease the air:fuel ratio temporarily. Some embodiments of method 300 may include functionality to identify periods of deviant air:fuel mixture and adjust the measure of fuel consumption accordingly. Regardless of whether method 300 accounts for variable fuel mixtures, the receiving and possible recording of fuel consumption data from the powertrain in block 308 may be performed substantially continuously, periodically, asynchronously, or in response to an interrupt or user signal. As indicated previously, other sensor signals provided by powertrain 130 to may be acquired to estimate fuel consumption.

While fuel consumption information is being acquired in block 308, method 300 monitors (block 310) for a second triggering event. The second triggering event may be used to determine a point at which a second reading of the fuel gauge is taken. The second triggering event may be of the same type of event as the first triggering event. If, for example, the first triggering event is the detection of a refueling event, the second triggering event may be a subsequent refueling event. In such embodiments, the fuel gauge reading may be monitored every time a refueling event is detected. As each refueling event occurs, method 300 detects the fuel gauge reading and records it. Between refueling events, method 300 acquires fuel consumption data from powertrain 130 or from an powertrain sensor 132. In other embodiments, the triggering events may be related to turning the vehicle powertrain on and off or some other suitable event. Triggering based on the on/off signal effectively creates a new fuel consumption interval for each car trip.

When the second triggering event is detected in block 312, the fuel consumption data acquired from powertrain 130 is used to determine (block 320) a fuel consumption estimate. Determining the fuel consumption estimate from the fuel consumption data may be achieved using various techniques and/or algorithms. If the fuel consumption data was received and recording substantially continuously, the fuel consumption data can be integrated over time to obtain a value. Where the fuel consumption data is recorded periodically, for example, at a predetermined state in the powertrain cycle, the fuel consumption estimate might include the use of an algorithm that assumes a linear function between adjacent data points.

It will be appreciated that, because the fuel consumption estimate is based on data that is not affected by the readings from fuel gauge 104, the fuel consumption estimate determined in block 320 is determined independent of fuel gauge 104 and is referred to herein as an independently derived estimate of fuel consumption. In addition, method 300 includes recording a second reading (322) of fuel gauge signal 112. With the first and second readings of fuel gauge signal 112 and the independent estimate of fuel consumption, method 300 is able to update (324) local fuel consumption database 240 with a new data point indicating the fuel consumption corresponding to a change of the fuel gauge from the first fuel gauge position to the second fuel gauge position.

Method 300 as depicted in FIG. 3 may include maintaining and updating local fuel consumption data when an estimate of fuel consumption is made in block 320. For example, local fuel consumption database 240 may include a running average of mileage attained by the vehicle. The mileage may be derived from the fuel consumption estimate in conjunction with readings from an odometer of the vehicle. The fuel consumption estimate generated in block 320 may be used to generate a mileage estimate based. The mileage estimate may be used to modify a historical fuel consumption value either upwards or downward according to the data. In this manner, the most recently generated fuel consumption estimates are used to keep the historical estimates of mileage and fuel consumption current.

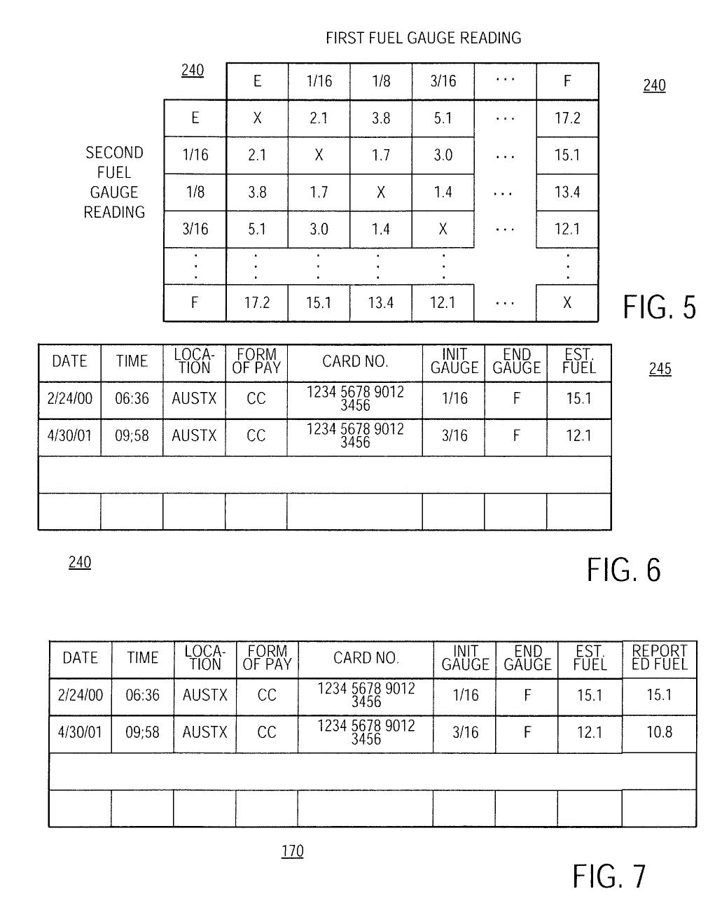

Referring momentarily to FIG. 5, a conceptual depiction of a representative fuel consumption database 240 is presented. In the depicted implementation, fuel consumption database 240 is depicted as a table that includes an axis representing an initial fuel gauge reading and an axis that represent a subsequent fuel gauge. Any pair of fuel gauge readings (incremented in 1/16ths in the depicted embodiment for the sake of safety) define a single block in the database. The value in the single block indicates the amount of fuel corresponding to a change in fuel gauge reading from the first fuel gauge reading to the second.

In addition to providing accurate fuel consumption information, another aspect of the fuel monitor 160 concerns fraud detection and prevention. Embodiments of system 100 as depicted in FIG. 1 and FIG. 2 address fraud detection and prevention by comparing the independently derived fuel consumption data to fuel consumption information reported by drivers or other operators of fleet vehicles. In at least some of these embodiments, fuel fraud detection is an extension of the fuel consumption determination process described above with respect to FIG. 3. More specifically, some embodiments of system 100 transmit export at least some portions of local fuel consumption database 240 to an external data processing system. The external data processing system may receive fuel consumption data from a second source and compare the fuel consumption data from the second source to the fuel consumption data recorded in local database 240. In some embodiments, the second source of fuel consumption data is provided by a fleet driver or operator or by a refueling receipt received by the fleet operator.

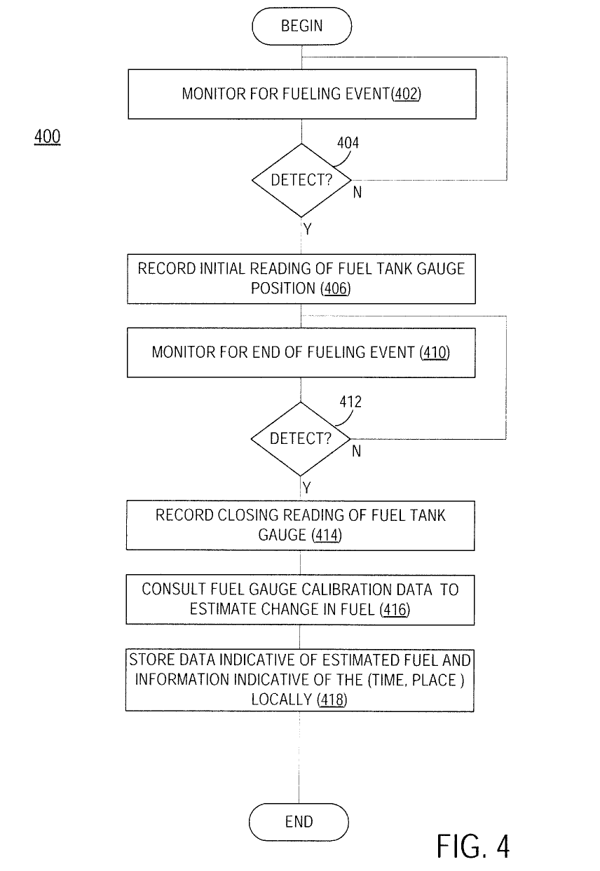

Referring now to FIG. 4, a flow diagram depicts a method 400 that is performed when processing module 201 of fuel monitor 160 executes one embodiment of refueling module 230. In the depicted implementation, method 400 includes monitoring (block 402) for a refueling event. If (block 404) a beginning of a refueling event is detected, for example, by detecting an increase in the rate of change of fuel gauge signal 112, a first reading of fuel gauge signal 112 is taken and recorded (block 406). Method 400 then monitors (block 408) for an end of the refueling event, for example, by detecting a decrease or cessation in the rate of change of fuel gauge signal 112. Upon detecting the end of the refueling event (block 410), method 400 performs and records (block 412) a second recording of fuel gauge signal 112.

Method 400 then uses the recorded first and second readings of fuel gauge signal 112 to determine the estimated amount of fuel that would be required to change fuel gauge signal 112 from the first reading to the second reading. Specifically, method 400 includes using the first and second readings of fuel gauge signal 112 as inputs into local fuel consumption database 240. In this manner, method 400 consults (block 420) local fuel consumption database to determine the amount of fuel corresponding to a pair of readings of fuel signal 112. Method 400 as depicted further includes storing (block 422) the independently determined amount of fuel along with other data indicative of the refueling event. The refueling event data might include, for example, the date and time, the geographic location for an embodiment in which fuel monitor 160 includes or has access to a geographic positioning device, and any other information that might facilitate subsequent verification of the transaction.

In some embodiments, method 400 may further include transmitting (block 424) the refueling information, as well as other information stored in local fuel consumption database 240, to an external database, for example, external refueling database 170. Transmission of the locally stored refueling information may be achieved wirelessly in embodiments of fuel monitor 160 that includes wireless functionality. In other embodiments, information in local fuel consumption database 240 may be transmitted to external fuel consumption database, or to a different external destination via a wired connection including, as examples, the USB connection suggested by USB port 250 depicted in FIG. 2 and the Ethernet connection suggested by Ethernet port 260.

Referring to FIG. 6 and FIG. 7, embodiments of an exemplary local refueling database 245 and an external refueling database 170 are shown. In the depicted embodiments, local refueling database 245 includes a plurality of refueling entries represented by the rows in the table 245. Each entry includes information indicative of the refueling event. Included in refueling database 245 is a pair of columns to store and record an initial and an ending reading of fuel gauge signal 112. The pair of fuel gauge readings will be used to consult fuel consumption database 240 to retrieve the appropriate estimated fuel consumption value. In FIG. 7, an exemplary external refueling database 170 includes a plurality of entries much like the local refueling database. The entries in external refueling database 170, however, include a column for recording the amount of fuel reported to the system by a driver or operator. It can be seen that the entry corresponding to the date Apr. 30, 2001 contains a value of 12.1 gallons of fuel estimated by fuel consumption module 230 and a value of only 10.8 gallons as reported by the driver or operator. In some cases, this discrepancy will be detected and reported for investigation to determine the cause of the discrepancy.

After the data in local fuel consumption database 240 and information in external refueling database 170 are stored on a commonly accessible system or media, application programs may perform various checks to determine whether the information pertaining to a particular refueling transaction as reported by external refueling database 170 matches the information pertaining to the same refueling transaction as reported by locally stored database 240. For example, an application program may be operable to match a refueling transaction stored on local fuel consumption database 240 with a refueling transaction stored on external refueling database 170. This matching might be achieved by comparing dates and times and other parameters of interest pertaining to individual refueling transactions. Once a transaction stored on local fuel consumption database 240 is matched to a transaction in external refueling database 170, the application program may then determine whether the transactions have a substantially equal indication of the amount of fuel that was used during the transaction.

It will be appreciated by those of ordinary skill in the field having the benefit of this disclosure that the disclosure describes a method, system, and method for collecting data regarding fuel consumption and refueling and for using the collected data to reduce or prevent discrepancies between the amount of fuel indicated as being purchased in a first (local) database and the amount of fuel indicated as being purchased in the second (external) database.

What is claimed:

1. A fuel monitoring device for use with a motor vehicle, comprising:
a processing module;
an interface facilitating communication between the processing module and an electronic control module (ECM) and operable to receive a fuel gauge signal and at least one powertrain signal from the ECM;
a storage device comprising a computer readable medium accessible to the processing module; and
a code module including instructions embedded in the computer readable medium and executable by the processor, wherein the code module includes:
instructions to determine from the at least one powertrain signal an amount of fuel consumed by the motor vehicle during an interval;
instructions to detect a first reading of the fuel gauge signal at the beginning of the interval and to detect a second reading of the fuel gauge signal at the end of the interval; and
instructions to associate the amount of fuel consumed with the first and second readings of the fuel gauge signal.

2. The device of claim 1, wherein the at least one powertrain signal comprises a mass air flow signal (MAF).

3. The device of claim 1, further comprising,
instructions to repeat said determining, said detecting, and said associating to build a fuel consumption database including information indicative of an amount of fuel consumption associated with a pair of fuel gauge readings; and
instructions to store the fuel consumption database in said storage device.

4. The device of claim 3, further comprising instructions to transmit the fuel consumption database to an external data processing system.

5. The device of claim 4, further comprising a wireless transmitter, wherein said instructions to transmit comprise instructions to transmit wirelessly said fuel consumption database.

6. The device of claim 5, wherein said instructions to transmit wirelessly comprise instructions to transmit wirelessly to a wireless receiver using a local wireless technology.

7. The device of claim 6, wherein said instructions to transmit wirelessly using a local wireless technology comprise instructions to transmit wirelessly to a wireless receiver of a fuel pump.

8. The device of claim 1, further comprising, instructions to calculate a mileage figure associated with the amount of fuel consumed.

9. The device of claim 8, further comprising instructions to update a historical mileage figure to reflect the calculated mileage figured.

10. A fuel consumption device suitable for insertion into a communications port of a motor vehicle, wherein said device is operable to:
receive a fuel gauge signal and one or more powertrain signals;
estimate fuel consumption based on said one or more powertrain signals;
use estimated fuel consumption data to generate a fuel consumption database indicative of a relationship between readings of said fuel gauge signal and actual amounts of fuel; and
responsive to detecting a refueling event, consult a fuel consumption database to determine an estimated amount of fuel associated with the refueling event.

11. The device of claim 10, wherein said one or more powertrain signals include a mass air flow signal.

12. The device of claim 10, wherein said device is further operable to store said fuel consumption database locally.

13. The device of claim 10, wherein said device is further operable to transmit said fuel consumption database remotely.

14. The device of claim 13, wherein said device is further operable to record and transmit a record of said refueling event including said estimated amount of fuel.

15. A method of monitoring fuel consumption, comprising:
responsive to detecting a beginning of a refueling event, recording a beginning reading of the fuel gauge;
responsive to detecting an ending of a refueling event, recording an ending reading of the fuel gauge; and
consulting a fuel consumption database indicative of a relationship between fuel gauge readings and fuel consumption to determine an amount of fuel associated with the beginning and ending readings.

16. The method of claim 15, further comprising recording the amount of fuel in a refueling database.

17. The method of claim 16, further comprising recording additional data associated with the refueling event, wherein said additional data is selected from the group of data categories consisting of: time of day, date, location, form of payment, credit card number, and receipt number.

18. The method of claim 16, further comprising transmitting the refueling database to an external data base.

19. The method of claim 18, further wherein said external database includes a reported amount of fuel associated with the refueling event.

20. The method of claim 19, further comprising detecting a discrepancy between the determined amount of fuel and the reported amount of fuel.
